(19) United States
(12) Patent Application Publication
(10) Pub. No.: US 2022/0390751 A1
(43) Pub. Date: Dec. 8, 2022

(54) IMAGE DISPLAY DEVICE AND ADJUSTMENT METHOD

(71) Applicant: SONY GROUP CORPORATION, Tokyo (JP)

(72) Inventors: Takaaki YOSHIDA, Kanagawa (JP); Hiroshi MUKAWA, Kanagawa (JP)

(73) Assignee: SONY GROUP CORPORATION, Tokyo (JP)

(21) Appl. No.: 17/775,045

(22) PCT Filed: Oct. 6, 2020
(86) PCT No.: PCT/JP2020/037799

§ 371 Date: May 6, 2022

(30) Foreign Application Priority Data
Nov. 15, 2019 (JP) 2019-206860

(51) Int. Cl. G02B 27/01

(52) U.S. Cl. CPC G02B 27/0176; G02B 27/0179; G02B 2027/0181; G02B 2027/0159; G02B 2027/0178

(57) ABSTRACT

There are provided: a display unit that is allowed to converge light forming a display image in a pupil of an eyeball and project the light on a retina and that has translucency; and a moving unit that is allowed to move the display unit in triaxial directions of an eye relief direction and two axial directions, the eye relief direction being a direction of a distance between the eyeball and the display unit, the two axial directions constituting a plane perpendicular to the eye relief direction. The moving unit includes a biaxial moving mechanism that is allowed to move the display unit in accordance with a position of the pupil of the eyeball in two axial directions, which are not parallel to each other, constituting a plane perpendicular to the eye relief direction. The moving unit includes an eye relief direction moving mechanism that is allowed to move the display unit in the eye relief direction.

### FIELD

The present disclosure relates to an image display device and an adjustment method.

### BACKGROUND

There is known a retinal projection display based on Maxwell view, specifically a retinal projection head mounted display (hereinafter, also referred to as retinal projection HMD) (see Patent Literature 1). Such a display causes an observer to visually recognize a display image by once converging image light beams based on the display image in a pupil of an eyeball of the observer and projecting the image light beams on the retina.

### CITATION LIST

### Patent Literature

Patent Literature 1: JP 2019-113794 A

### SUMMARY

### Technical Problem

The above-described retinal projection display once converges image light beams of a display image a pupil, so that a position of the pupil on a plane, where an observer can watch the display image, is determined uniquely. In order to avoid this situation, there can be considered methods and the like, in which, for example, an optical display of a retinal projection HMD is translated with an actuator, and a movable mirror is used to change the direction of an image light beam so that the display image is not made invisible even when the pupil moves. When the maximum angle of view of the display image is widened, however, an allowable range in a direction of the distance between the optical display and the pupil (hereinafter, eye relief direction) is narrowed. Vignetting is generated in the display image in the state of front view or when the pupil moves, which causes a problem that not all the display images can be visually recognized.

Therefore, the present disclosure proposes an image display device and an adjustment method that allow visual recognition of a display image with inhibited vignetting.

### Solution to Problem

An image display device according to the present disclosure includes: a display unit, of transmissive type, that is allowed to converge light forming a display image in a pupil of an eyeball and project the light on a retina; and a moving unit that is allowed to move the display unit in triaxial directions of an eye relief direction and two axial directions, the eye relief direction being a direction of a distance between the eyeball and the display unit, the two axial directions constituting a plane perpendicular to the eye relief direction.

### BRIEF DESCRIPTION OF DRAWINGS

FIG. 1A illustrates the principle of Maxwell view studied by the present discloser.

FIG. 1B illustrates the principle of Maxwell view studied by the present discloser.

FIG. 2 illustrates problems studied by the present discloser.

FIG. 3 illustrates the problems studied by the present discloser.

FIG. 4A is a perspective view illustrating a retinal projection HMD according to an embodiment of the present disclosure.

FIG. 4B is a top view illustrating the retinal projection HMD according to the embodiment of the present disclosure.

FIG. 4C is a front view illustrating the retinal projection HMD according to the embodiment of the present disclosure.

FIG. 5 is an exploded perspective view illustrating the structure of the retinal projection HMD according to the embodiment of the present disclosure.

FIG. 6 is an exploded perspective view illustrating a movement mechanism in biaxial directions perpendicular to an eye relief direction of the retinal projection HMD according to the embodiment of the present disclosure.

FIG. 7 is a perspective view illustrating a screw feeding mechanism, which is a manual eye relief direction moving mechanism of the retinal projection HMD according to the embodiment of the present disclosure.

FIG. 8 is a flowchart illustrating a method of adjusting a display image of the retinal projection HMD according to the embodiment of the present disclosure.

FIG. 9A is an example of an adjustment image for illustrating the method of adjusting the retinal projection HMD according to the embodiment of the present disclosure.

FIG. 9B is an example of a display image with no image loss for illustrating the method of adjusting the retinal projection HMD according to the embodiment of the present disclosure.

FIG. 9C is an example of a display image with image loss for illustrating the method of adjusting the retinal projection HMD according to the embodiment of the present disclosure.

FIG. 10A is a perspective view illustrating a lock mechanism, which is a manual eye relief direction moving mechanism of a retinal projection HMD according to a first variation of the embodiment cf the present disclosure.

FIG. 10B is a perspective view illustrating the lock mechanism, which is the manual eye relief direction moving mechanism of the retinal projection HMD according to the first variation of the embodiment of the present disclosure.

FIG. 11 is a perspective view illustrating a retinal projection HMD according to a second variation of the embodiment of the present disclosure.

FIG. 12A is a perspective view illustrating an eye relief direction moving mechanism of the retinal projection HMD according to the second variation of the embodiment of the present disclosure.

FIG. 12B is a perspective view illustrating an automatic eye relief direction moving mechanism of the retinal projection HMD according to the second variation of the embodiment of the present disclosure.

FIG. 13 is a top view illustrating an eye tracking function of the retinal projection HMD according to the second variation of the embodiment of the present disclosure.

### DESCRIPTION OF EMBODIMENTS

An embodiment of the present disclosure will be described in detail below with reference to the drawings. Note that, in the following embodiment, the same reference signs are attached to the same parts to omit duplicate description.

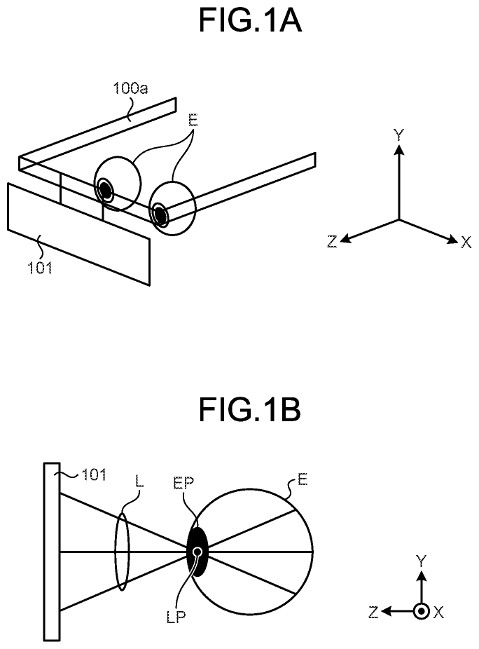

Before describing the embodiment of the present disclosure, an intensive study that has been conducted by the present discloser to solve the above-described problems will first be described. FIGS. 1A and 1B illustrate problems of the background art.

As illustrated in FIG. 1A, a retinal projection head mounted display (hereinafter, retinal projection HMD) 100 according to the background art includes a semi-transmissive display unit 101 capable of transmitting visible light on the pupil side of an eyeball B of an observer. As illustrated in FIG. 1B, the translucent display unit 101 can converge image light L forming a display image in a pupil EP of the eyeball E to project the image light L on the retina. That is, the retinal projection HMD uses Maxwell view. This allows the observer to visually recognize the display image without an influence on the functions of a crystalline lens of the observer. Note that, in FIGS. 1A and 1B, a direction of the arrangement of the two eyeballs E is defined as an X-axis direction, a direction of the distance between the eyeballs E and the display unit 101 is defined as a Z-axis direction, and a direction perpendicular to the X-axis direction and the Z-axis direction is defined as a Y-axis direction.

Here, the retinal projection HMD 100 once converges the image light of the display image in the pupil EP. Therefore, the position of the pupil EP on an XY plane, where the observer can watch the display image, is determined uniquely. That is, if the position of the pupil EP greatly deviates from a convergence point LP of the image light L, the observer cannot visually recognize the display image. In response, there can be considered a method in which the display unit 101 is translated to a position corresponding to the position of the pupil by using an actuator or the like in order to allow the display image to be visually recognized even if the pupil EP moves. Furthermore, there can also be considered a method in which a movable mirror chances the incident position of the image light IL to the position of the pupil EP. That is, the present discloser has found a method of avoiding the problem that movement of the pupil EP prevents visual recognition of the display image by positioning the convergence point LP of the image light L in the vicinity of the pupil EP.

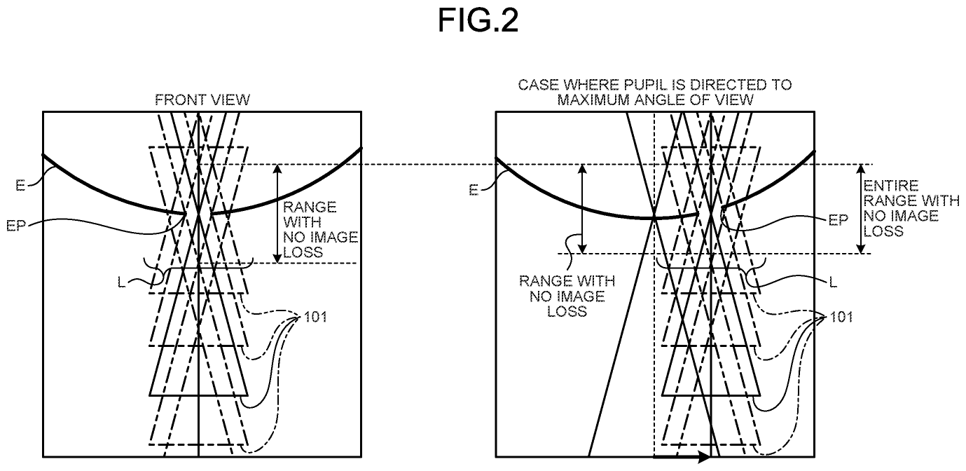

Then, the present discloser has further studied a method of positioning the convergence point LP of the image light L in the vicinity of the pupil EP, and has found the following problems. That is, when the display image output by the display unit 101 has a narrow maximum angle of view equal to or less than 30 degrees, the above-described method can inhibit a problem that the display image cannot be visually recognized even if the pupil EP moves. FIG. 2 illustrates this state. FIG. 2 is a conceptual diagram illustrating an incident state of image light in a case where the display image has a narrow maximum angle of view equal to or less than 30 degrees. Note that FIG. 2 is viewed from the Y-axis direction, and the vertical direction corresponds to the Z-axis direction.

As illustrated in FIG. 2 in front view (left figure), when the pupil EP of the eyeball E faces the front, the image light L passes through the pupil EP and the entire display image can be visually recognized even if the convergence point of the image light L somewhat deviates from the state indicated by a solid line to the inside or outside of the eyeball E. In the present specification, this state is referred to as “no image loss”. Here, when the pupil EP has a pupil diameter ϕ of 2 mm, the range with no image loss in front view has a length of 7.5 mm in the Z-axis direction.

Then, when the pupil EP is moved from the state in FIG. 2 in front view (left figure) to a case where the pupil is directed to the maximum angle of view in FIG. 2 (right figure), the display unit 101 moves in accordance with the position of the pupil EP according to the above-described method. This allows, in the state of the right figure of FIG. 2, the image light L to pass through the pupil EP and allows The entire display image to be visually recognized even if the convergence point of the image light L somewhat deviates from the state indicated by a solid line to the inside of outside of the eyeball E. In the example of the right figure of FIG. 2, a range with no image loss has a length of 6.7 mm in the Z-axis direction. From the above points, when the pupil EP is moved from right to left (substantially in X-axis direction), all the image light from the display unit 101 passes through the pupil EP as long as a movement range in the Z-axis direction is an “entire range with no image loss”. Here, the range with no image loss has a length of 6.6 mm. That is, even when the distance between the position of the eyeball E and the display unit 101 is deviated back and forth by 6.6 mm, no image loss and vignetting of the display image is generated.

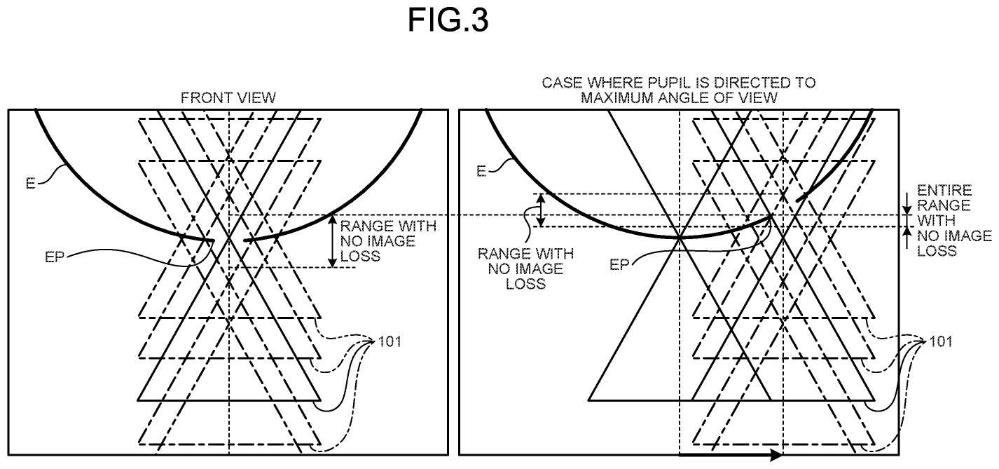

In contrast, when the display image output by the display unit 101 has a wide maximum angle of view of, for example, approximately 60 degrees, the range with no image loss of the eyeball E is 3.5 mm in the Z-axis direction as illustrated in FIG. 3 in front view (left figure). Note that the pupil EP has a pupil diameter ϕ of 2 mm as described above. Moreover, when the pupil EP is moved from the state in FIG. 3 in front view (left figure) to a case where the pupil is directed to the maximum angle of view in FIG. 3 (right figure), the display unit 101 moves in accordance with the position of the pupil EP. The range with no image loss in the right figure of FIG. 3 has a length of 2.0 mm in the Z-axis direction. From the above points, when the pupil EP is moved from right to left (substantially in X-axis direction), the entire range with no image loss has a length of approximately 1.0 mm. That is, when the distance between the position of the eyeball E and the display unit 101 is deviated back and forth by 1.0 mm, image loss and vignetting of the display image is generated.

Moreover, it is assumed that the range with no image loss in the case of FIG. 3 in front view does not overlap the range with no image loss in the case where the pupil is directed to the maximum angle of view. In this case, there is no entire range with no image loss described above. In this case, no matter how an eye relief between the eyeball E and the display unit 101 is adjusted, the image loss and vignetting of the display image are always generated. when the pupil of the eyeball E is directed to the maximum angle of view. The present discloser conducted an intensive study to find the above-described problems related to the retinal projection HMD.

Then, the present discloser further has studied a method of inhibiting image loss of a display image in a case where the display image of the retinal projection HMD has an increased maximum angle of view. As a result, the present discloser has devised a method of introducing an eye relief adjustment mechanism capable of moving a display unit, in an eye relief direction, to a portion supporting the display unit in a glasses-type retinal projection HMD. This allows the display unit to be moved to a desired position or an optimum position along the eye relief direction (Z direction in FIG. 1A). Therefore, even when the display image on the display unit has a wide maximum angle of view of, for example, 60 degrees or more, the entire display image can be visually recognized without vignetting when the pupil EP is moved. The present disclosure described below has been devised through the above-described intensive study of the present discloser.

### Embodiment

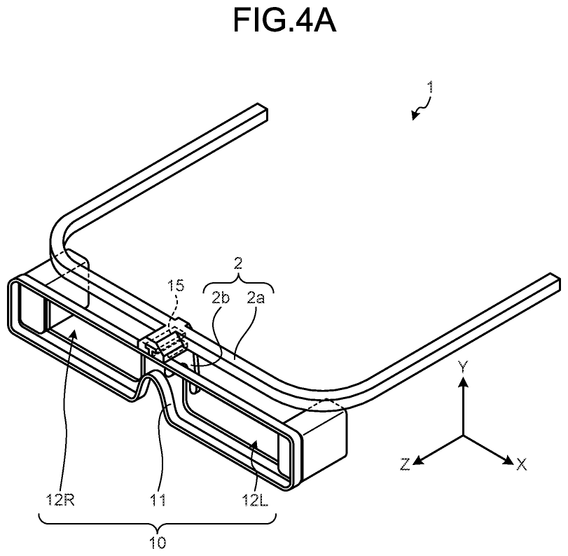

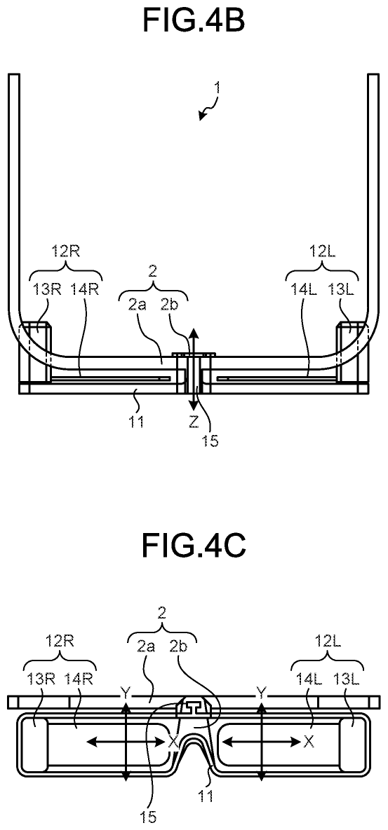

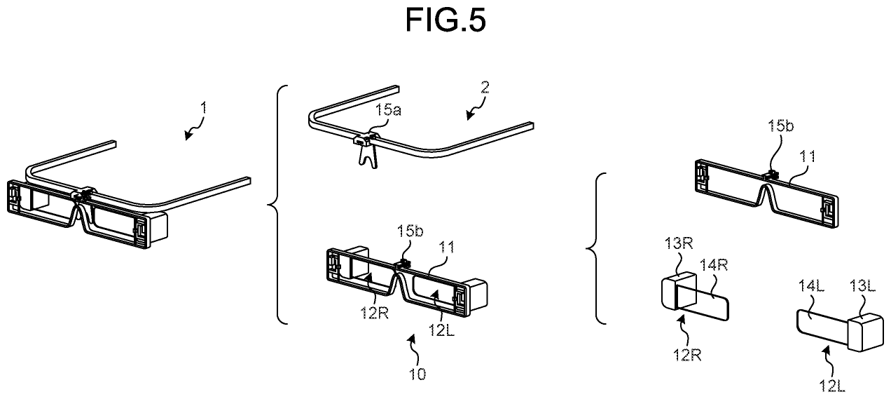

A retinal projection HMD, which is an image display device according to an embodiment of the present disclosure, will be described below. FIGS. 4A, 4B, and 4C are a perspective view, a top view, and a front view, respectively, of a retinal projection HMD 1 according to the embodiment. FIG. 5 is an exploded perspective view of the retinal projection HMD 1 according to the embodiment. Note that, in FIGS. 4A, 4B, and 4C, the X-axis direction, the Y-axis direction, and the Z-axis direction of triaxial directions orthogonal to each other are defined as illustrated in the figures.

As illustrated in FIGS. 4A and 5, the retinal projection HMD 1 according to the embodiment includes a wearable block 2 and a front display block 10. The wearable block 2 has, for example, a U-shaped temple 2a provided with an inverted V-shaped nose pad 2b. The front display block 10 can be attached to the wearable block 2. Note that the temple 2a is not limited to having the U-shape as long as the temple 2a has a shape in which the temple 2a can be worn on a head of a person and the like. The temple 2a can have various shapes such as an O-shape and a V-shape.

The position of the wearable block 2 with respect to the head of an observer (user) is determined by the temple 2a and the nose pad 2b. That is, the wearable block 2 does not move with respect to the head of the observer wearing the retinal projection HMD 1. The front display block 10 includes a front frame 11, a right optical block 12R, and a left optical block 12L. The front frame 11 has a shape of a frame of normal glasses, and serves as a holding unit that holds the right optical block 12R and the left optical block 12L.

As illustrated in FIGS. 4B and 5, an eye relief adjustment mechanism 15 is configured by connecting a worn-side mechanism 15a with a front-side mechanism 15b such that the worn-side mechanism 15a and the front-side mechanism 15b can be relatively moved. The worn-side mechanism 15a serves as a hanging unit. The front-side mechanism 15b is a part of the holding unit. The worn-side mechanism 15a is provided at a central upper portion in the vicinity of the nose pad 2b of the wearable block 2. The front-side mechanism 15b is fixed to an upper portion of a central portion in the longitudinal direction of the front frame 11. The eye relief adjustment mechanism 15 can relatively move the wearable block 2 and the front display block 10. That is, the front display block 10 is hung from the wearable block 2 at the portion of the eye relief adjustment mechanism 15, and can move with respect to the wearable block 2. Note that the position of connection between the wearable block 2 and the front frame 11 is not necessarily limited to the one central position. The wearable block 2 and the front frame 11 may be connected to each other at a plurality of portions in the vicinities of both ends or in a part of an upper portion or a lower portion of the front frame 11.

The eye relief adjustment mechanism 15 can translate the front display block 10 in a direction substantially perpendicular to the surfaces of the display units 14L and 14R, the Z-axis direction in FIGS. 4A and 4B. In other words, the eve relief adjustment mechanism 15 can move the front display block 10 in the eye relief direction. That is, the eye relief adjustment mechanism 15 adjusts an eye relief, which is a distance between the pupil EP of the eyeball E and the display units 14L and 14R, when the observer wears the retinal projection HMD 1. Although the display units 14L and 14R include flat glass and the like here, the display units 14L and 14R may include curved glass. Even when the display units 14L and 14R have a curved shape, translation can be performed. In the translation, a contact surface at any position in the curved surface is maintained in parallel. Since the wearable block 2 does not move with respect to the head of the observer and the front display block 10 moves with respect to the wearable block 2, the distance between the front display block 10 and the pupil EP of the observer is easily adjusted.

As illustrated in FIGS. 4C and 5, the front frame 11 holds the right optical block 12R and the left optical block 12L to constitute the front display block 10. In the right optical block 12R, an optical engine unit 13R supports a semi-transmissive display unit 14R that transmits a part of visible light. The display unit 14R is a right-eye image display unit that sends an image toward the right eye of the observer. In the left optical block 12L, an optical engine unit 13L supports a semi-transmissive display unit 14L that transmits a part of visible light. The display unit 14L is a left-eye image display unit that sends an image toward the left eye of the observer.

Each of the display units 14L and 14R is provided substantially in parallel to the XY plane. The optical engine units 13L and 13R are integrated with the display units 14L and l4R, respectively, and can translate in the X-axis direction and the Y-axis direction in the XY plane. That is, the display units 14L and 14R and the optical engine units 13L and 13R can translate in a direction substantially perpendicular to the eye relief direction with respect to the front frame 11. The optical engine units 13L and 13R can execute eye tracking on the observer wearing the retinal projection HMD 1 by a conventionally known method. The eye tracking is a method of tracking movements of the pupil EP by sensing a line-of-sight position of the observer with a sensor (not illustrated) provided in the optical engine units 13L and 13R. The optical engine units 13L and 13R cause the display units 14L and 14R to immediately and automatically follow the position in the XY plane of the pupil EP of the observer obtained by the eye tracking with an actuator to be described later. Here, the optical engine units 13L and 13R move the display units 14L and l4R such that the convergence point LP of the image light from the display units 14L and l4R is located in the vicinity of the pupil EP. This allows at least a part of the image light from the display units 14L and 14R to be incident on the inside of the pupil EP.

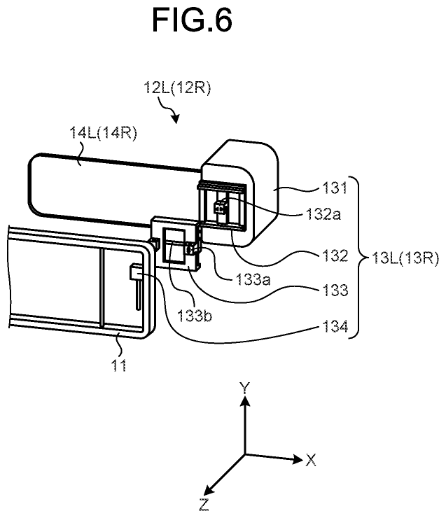

FIG. 6 is an exploded perspective view illustrating a biaxial moving mechanism that can move in biaxial directions not parallel to each other perpendicular to the eye relief direction of an optical block. The biaxial directions include, for example, the X-axis direction and the Y-axis direction orthogonal to each other. The biaxial directions may be those such as a rotation direction and a radial direction. FIG. 6 illustrates details of the optical engine unit 13L of the left optical block 12L. As illustrated in FIG. 6, the optical engine unit 13L includes an engine base 131, an X frame 132, a Y frame 133, and a Y-axis ultrasonic linear actuator 134. The display unit 14L is fixed to the engine base 131. The X frame 132 is fixed on the side of the front frame 11 of the engine base 131. An X-axis ultrasonic linear actuator 133b is provided on the side of the engine base 131 of the Y frame 133. A moving object 132a is fixed to the X frame 132. A drive shaft of the X-axis ultrasonic linear actuator 133b penetrates the moving object 132a. This allows the engine base 131 to move in the X-axis direction with respect to the Y frame 133 by driving the X-axis ultrasonic linear actuator 133b. The Y-axis ultrasonic Linear actuator 134 is provided in the vicinity of one end of the front frame 11. A moving object 133a is fixed on the side of the front frame 11 of the Y frame 133. A drive shaft of the Y-axis ultrasonic linear actuator 134 penetrates the moving object 133a. This allows the Y frame 133 to move in the Y-axis direction with respect to the front frame 11 by driving the Y-axis ultrasonic linear actuator 134. Each of the X-axis ultrasonic linear actuator 133b and the Y-axis ultrasonic linear actuator 134 described above includes a weight, a piezoelectric element, and a drive shaft that penetrates the moving object. As described above, the left optical block 121 can flatly move in the X-axis direction and the Y-axis direction with respect to the front frame 11. Note that the right optical block 12R is configured similarly to the left optical block 12L, and the description thereof will be omitted.

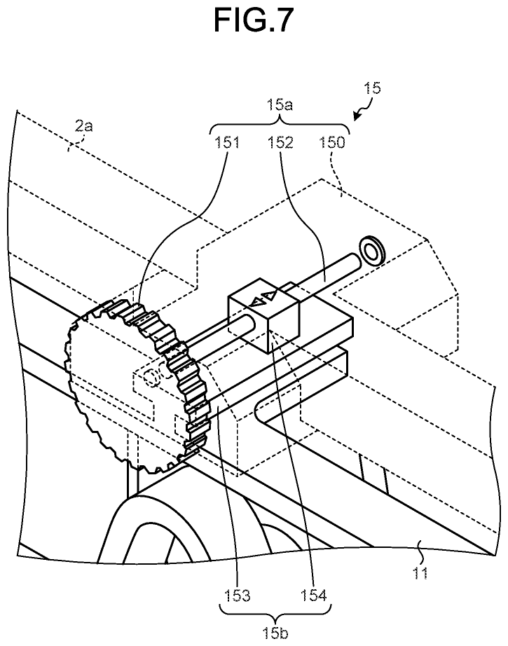

FIG. 7 is a perspective view illustrating details of the eye relief adjustment mechanism 15. The eye relief adjustment mechanism 15 in FIG. 7 is a so-called manual eye relief direction moving mechanism used for an observer or another operator to manually adjust an eye relief.

As described above, the eye relief adjustment mechanism 15 of the retinal projection HMD 1 according to the embodiment is configured by connecting the worn-side mechanism 15a with the front-side mechanism 15b. As illustrated in FIG. 7, the worn-side mechanism 15a includes a worn-side member 150, a tab portion 151, and a male screw portion 152. The tab portion 151 is rotatably connected to the worn-side member 150. The male screw portion 152 includes a shaft connected to the tab portion 151. The worn-side member 150 is fixed to a part of the temple 2a or the temple 2a. The front-side mechanism 15b includes a linear motion guide rail 153 and a female screw portion 154. The linear motion guide rail 153 is fixed to the front frame 11. The female screw portion 154 is fixed on the linear motion guide rail 153. The male screw portion 152 is fitted to the female screw portion 154. A lower portion of the worn-side member 150 is fitted to the linear motion guide rail 153. This allows, in the eye relief adjustment mechanism 15, a screw feeding mechanism to relatively move the female screw portion 154 to the male screw portion 152 by manually rotating the tab portion 151 attached to the wearable block 2 perpendicularly to the axis of the male screw portion 152. Therefore, the distance between the front frame 11 and the temple 2a can be adjusted. That is, the eye relief adjustment mechanism 15 can adjust the distance between the front display block 10 and the wearable block 2 in the Z-axis direction by rotating the tab portion 151. This allows the eye relief adjustment mechanism 15 to adjust the eye relief between the eyeball E and the pupil EP of the observer and the display units 14L and 14R. Using the screw feeding mechanism as the eye relief adjustment mechanism 15 according to the embodiment inhibits movement of the wearable block 2 at the time of adjusting the front display block 10, and allows stepless smooth adjustment.

The biaxial moving mechanism and the eye relief adjustment mechanism 15 described above constitute a moving unit that can move the optical blocks 12L and 12R in XYZ space.

(Method of Adjusting Eye Relief)

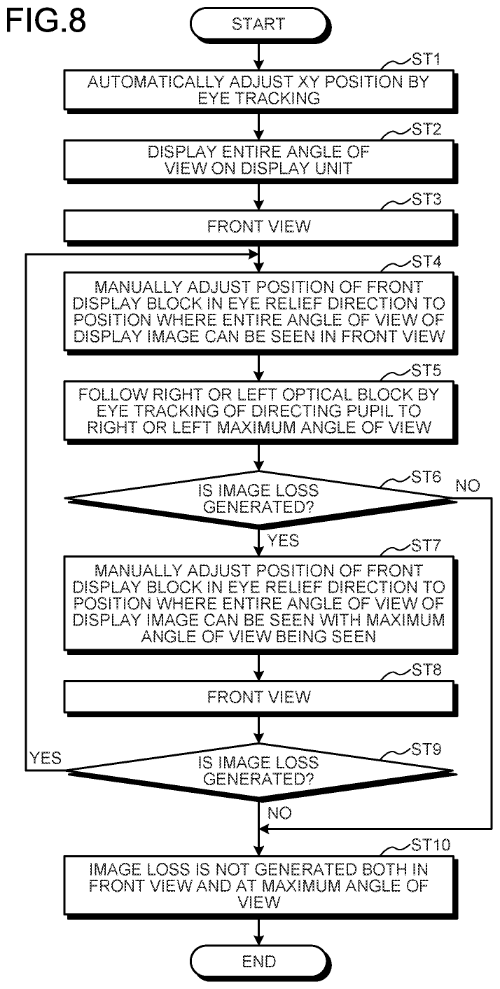

Next, a method of adjusting the above-described retinal projection HMD 1 will be described. FIG. 8 is a flowchart illustrating an adjustment method according to the embodiment. The adjustment method is executed with an observer wearing the retinal projection HMD 1. As illustrated in FIG. 8, first, in Step ST1, the optical engine units 13L and 13R of the retinal projection HMD 1 adjust the positions of the optical blocks 12L and 12R in the X-axis direction and the Y-axis direction with respect to the front frame 11 by an eye tracking function.

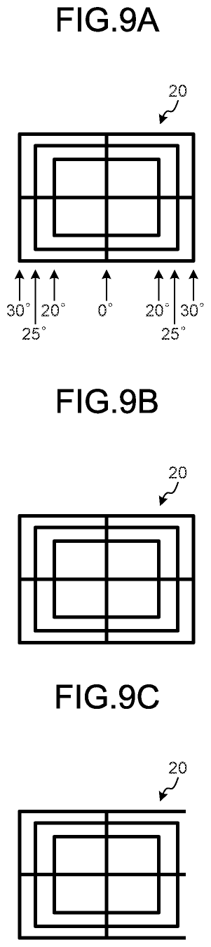

Next, the processing proceeds to Step ST2. The retinal projection HMD 1 displays an image over the entire angle of view of the display units 14L and 14R (display step). FIG. 9A illustrates one example of a display image for adjustment over the entire angle of view. An adjustment image 20 in FIG. 9A is an example of the adjustment image 20 in a case where the entire angle of view is 60 degrees in the X-axis direction. Note that, in the adjustment image 20, a straight line for adjustment is preferably displayed at a position of the displayable maximum angle of view in each of the X-axis direction and the Y-axis direction. That is, in the adjustment image 20 in FIG. 9A, the outermost rectangular line indicates the maximum range in which an image can be displayed on the display units 14L and 14R of the retinal projection HMD 1. Furthermore, when an image display region on the display units 14L and 14R has a vertically long shape, a vertically long adjustment display image having an entire angle of view of 60 degrees in the Y-axis direction may be used. That is, a shape in which the X-axis direction and the Y-axis direction of the adjustment image 20 in FIG. 9A are interchanged with each other may be adopted “Right and left” in the following description is interchanged with “up and down” when the image display region has a vertically long shape, for example.

Subsequently, in Step ST3 in FIG. 8, the retinal projection HMD 1 outputs an instruction for the observer to direct his/her line of sight to the front. The instruction of the retinal projection HMD 1 may be output on the display units 14L and 14R, and may be output by voice with a separately provided voice output device such as a speaker. The same applies hereinafter.

When the observer directs his/her line of sight to the front, the optical engine units 13L and 13R cause the display units 14L and 14R of the optical blocks 12L and 12R to follow the pupil EP of the observer on the XY plane by the eye tracking function (first following step). Then, the processing proceeds to Step ST4. The observer manually rotates the tab portion 151, for example, to adjust the position of the front display block 10 in the Z-axis direction until the entire adjustment image 20 can be seen as illustrated in FIG. 9B. That is, the observer adjusts the eye relief (first eye relief adjustment step). This allows the observer to visually recognize the entire adjustment image 20.

Next, the processing proceeds to Step ST5 in FIG. 8. The retinal projection HMD 1 outputs an instruction to move his/her line of sight to a position of either the right or left maximum angle of view to the observer. When the observer directs his/her line of sight to the position of either the right or left maximum angle of view, the optical engine units 13L and 13R cause the display units 14L and 14R to follow the pupil EP of the observer on the XY plane by the eye tracking function (second following step). Note that, when the image display region on the display units 14L and 14R has a vertically long shape, the retinal projection HMD 1 outputs an instruction to move his/her line of sight to the position of either the upper or lower maximum angle of view to the observer.

Next, the processing proceeds to Step ST6. The observer determines whether or not image loss as illustrated in FIG. 9C, for example, is generated in the visually recognized adjustment image 20. When the image loss is not generated (Step ST6: No), that is, when the observer can visually recognize the entire adjustment image 20 as illustrated in FIG. 9B, the processing proceeds to Step ST10 in FIG. 8. The retinal projection HMD 1 is in a state of no image loss both in front view and at the maximum angle of view for the observer wearing the retinal projection HMD 1. Thus, the processing of adjusting the retinal projection HMD 1 ends.

In contrast, in Step ST6, when the image loss as illustrated in FIG. 9C is generated (Step ST6: Yes), the processing proceeds to Step ST7. In Step ST7, similarly to Step ST4, the observer adjusts the eye relief until the observer become able to visually recognize the entire adjustment image 20 as illustrated in FIG. 9B in the state of seeing the maximum angle of view (second eye relief adjustment step).

Next, the processing proceeds to Step ST8. Similarly to Step ST3, the retinal projection HMD 1 outputs an instruction for the observer to direct his/her line of sight to the front. When the observer directs his/her line of sight to the front, the optical engine units 13L and 13R cause the display units 14L and 14R of the optical blocks 12L and 12R to follow the pupil EP of the observer on the XY plane by the eye tracking function.

Next, the processing proceeds to Step ST9. The observer determines whether or not image loss as illustrated in FIG. 9C, for example, is generated in the visually recognized adjustment image 20. When the image loss is not generated (Step ST9: No), the processing proceeds to Step ST10 in FIG. 8. In this case, the retinal projection HMD 1 is in a state of no image loss both in front view and at the maximum angle of view for the observer wearing the retinal projection HMD 1. Thus, the processing of adjusting the retinal projection HMD 1 ends.

In contrast, in Step ST9 when the image loss as illustrated in FIG. 9C is generated (Step ST9: Yes), the adjustment processing returns to Step ST4. Then, Steps ST4 to ST9 are repeatedly executed until the observer has no image loss both in front view and at the maximum angle of view. Thus, the processing of adjusting the retinal projection HMD 1 ends.

As described above, adjusting the eye relief adjustment mechanism 15 prevents occurrence of vignetting of the display image in a front view state and at the time when the line of sight is moved to move the pupil, and allows the entire angle of view of the display image to be seen. As a result, when the adjustment image 20 has a size of the entire range in which the adjustment image 20 can displayed on the display units 14L and 14R, the occurrence of vignetting can be prevented even if the observer moves his/her line of sight in the case where the observer wears the retinal projection HMD 1 and watches various images and videos.

(First Variation)

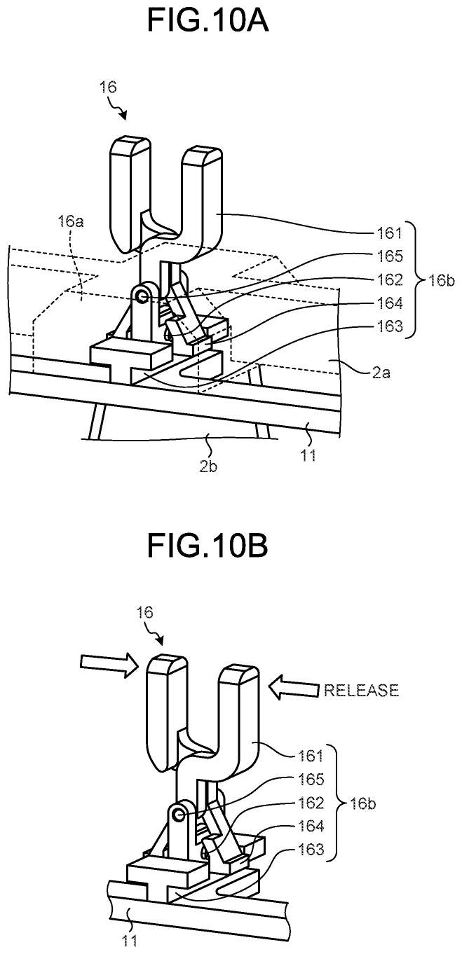

Next, a first variation of the above-described embodiment will be described. FIGS. 10A and 10B are perspective views illustrating details of an eye relief adjustment mechanism according to the first variation. An eye relief adjustment mechanism 16 in FIGS. 10A and 10B is a manual eye relief direction moving mechanism, and a so-called lock release tab mechanism.

As illustrated in FIG. 10A, the eye relief adjustment mechanism 16 of the retinal projection HMD 1 according to the first variation is configured by connecting a worn-side member 16a with a front-side mechanism 16b. The worn-side member 16a serves as a hanging unit. The front-side mechanism 16b serves as a part of a holding unit. Specifically, the worn-side member 16a includes a part of the temple 2a or a member fixed to the temple 2a. The worn-side member 16a can hang the front frame 11 by fitting or the like.

The front-side mechanism 16b includes a tab portion 161, a torsion coil spring 162, a guide rail 163 in the eye relief direction, a stopper portion 164, and a turning shaft 165, which are fixed to the front frame 11. The worn-side member 16a is fitted to a portion of the guide rail 163 to hang the front frame 11. The stopper portion 164 is biased outward by the torsion coil spring 162, and can be pressed so as to stretch against the inner wall of the worn-side member 16a. This causes the front-side mechanism 16b to be fixed to the worn-side member 16a in a manner in which the front-side mechanism 16b cannot slide on the worn-side member 16a. In contrast, as illustrated in FIG. 10B, when the tab portion 161 is pinched inward, the tab portion 161 turns around the turning shaft 165, and a portion on the side of the stopper portion 164 of the tab portion 161 compresses the torsion coil spring 162. This causes the stopper portion 164 to be separated from the inner wall of the worn-side member 16a, and causes the front-side mechanism 16b to be released from the worn-side member 16a, so that the lock is released. When the tab portion 161 is moved in the Z-axis direction with the tab portion 161 being pinched inward, the front-side mechanism 16b moves in the Z-axis direction (eye relief direction) along the guide rail 163. The above-described lock release tab mechanism adopted as the eye relief adjustment mechanism 16 can inhibit the movement of the side of the wearable block 2 at the time of adjusting the eye relief of the front display block 10, and allows stepless smooth adjustment.

(Second Variation)

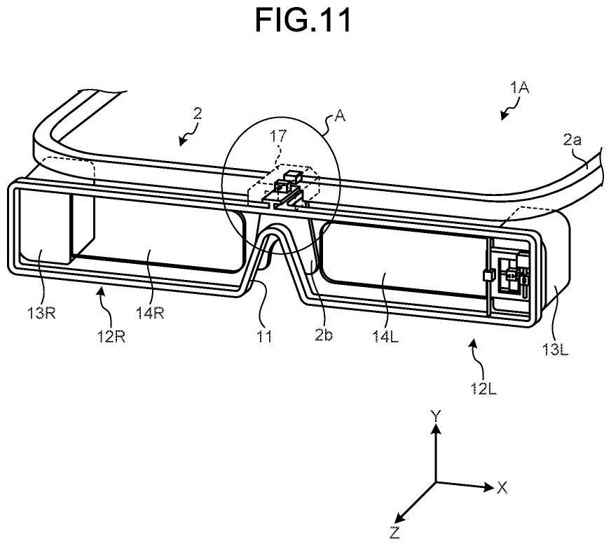

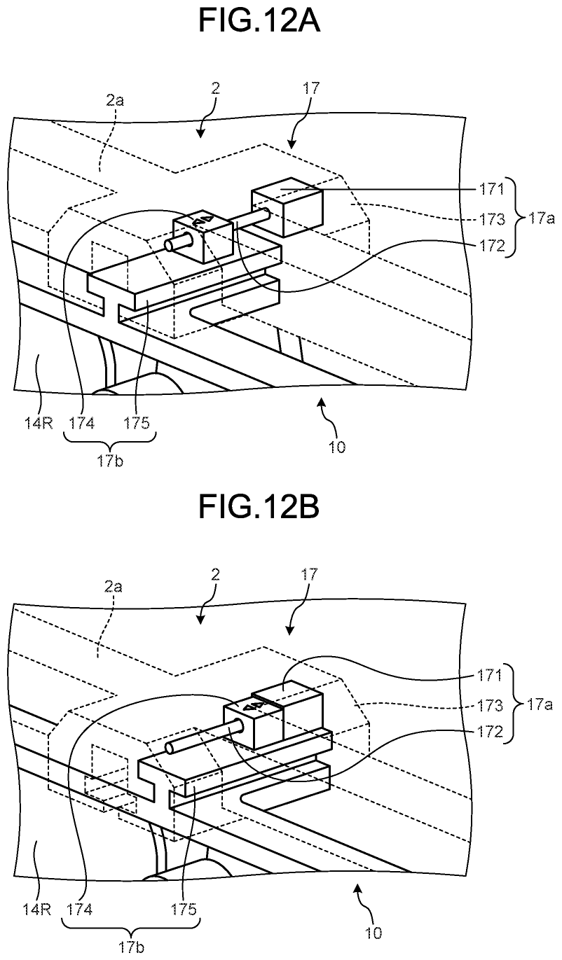

Next, a second variation of the above-described embodiment will be described. FIG. 11 is a perspective view of a retinal projection HMD 1A according to the second variation. FIGS. 12A and 12B are perspective views, which are obtained by enlarging a surrounded portion A in FIG. 11, illustrating details of an eye relief adjustment mechanism according to the second variation. An eye relief adjustment mechanism 17 in FIGS. 12A and 12B is a so-called automatic eye relief direction moving mechanism that automatically adjusts the eye relief without being operated by an observer or another operator.

As illustrated in FIG. 11, unlike the retinal projection HMD 1 according to the embodiment, the retinal projection HMD 1A according to the second variation includes the eye relief adjustment mechanism 17 that automatically adjusts the eye relief in the Z-axis direction.

As illustrated in FIGS. 12A and 12B, the eye relief adjustment mechanism 17 is configured by connecting a worn-side mechanism 17a with a front-side mechanism 17b. The worn-side mechanism 17a serves as a hanging unit. The front-side mechanism 17b serves as a part of a holding unit. The worn-side mechanism 17a is provided in the wearable block 2. The front-side mechanism 17b fitted to the worn-side mechanism 17a is provided on the side of the front frame 11. This allows the wearable block 2 to hang the front display block 10 with the worn-side mechanism 17a.

The eye relief adjustment mechanism 17 includes, for example, an ultrasonic linear actuator. That is, in the worn-side mechanism 17a, a piezoelectric element 171 having a weight and a drive shaft 172 are provided inside a worn-side member 173. In the front-side mechanism 17b, a moving object 174 which the drive shaft penetrates is fixed to a guide rail 175 in the eye re-Lief direction. The piezoelectric element 171, the drive shaft 172, and the moving object 174 constitute an ultrasonic linear actuator. Driving of the piezoelectric element 171 can be controlled to drive the ultrasonic linear actuator. That is, the front-side mechanism 17b and the worn-side mechanism 17a can be relatively moved in the eye relief direction (Z-axis direction) along the guide rail 175 by controlling driving of the piezoelectric element 171 and moving the moving object 174. This allows the front display block 10 to move with respect to the wearable block 2. FIG. 12A illustrates a state in which the front display block 10 is located at a front end of the wearable block 2. FIG. 12B illustrates a state in which the front display block 10 is located at a rear end of the wearable block 2.

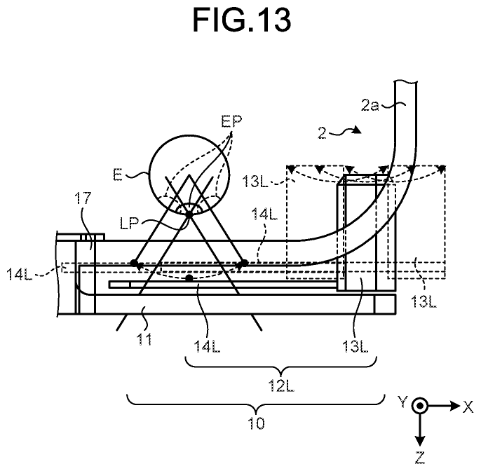

FIG. 13 is a top view of a portion of the left optical block 12L for illustrating eye tracking of the retinal projection HMD 1A. Note that, in the following description, the X-axis direction, the Y-axis direction, and the Z-axis direction are defined as in the figure. As illustrated in FIG. 13, when the pupil EP of the observer wearing the retinal projection HMD 1A moves, the left optical block 12L moves to a position parallel to the XY plane and corresponding to the movement of the pupil EP with respect to the front frame 11. At the same time, the eye relief adjustment mechanism 17 moves the front display block 10 along the Z-axis direction to prevent a change in the eye relief. That is, the eye relief adjustment mechanism 17 immediately adjusts the distance between the display unit 14L and the eyeball E by the eye tracking so that the variation of the eye relief caused by rotational movement of the pupil EP is offset at the time when the pupil EP rotationally moves up and down and right to left. In this case, a substantially central portion of the display unit 14L moves along a virtual spherical surface with the center of the eyeball E as the center of the sphere. This allows the convergence point LP of the image light L to be always located in the vicinity of the pupil EP even if the pupil EP rotationally moves. Therefore, even if the observer moves his/her line of sight, vignetting of the image displayed on the display unit 14L can be inhibited. Note that the same applies to the display unit 14R of the right optical block 12R.

According to the above-described embodiment, in the retinal projection HMDs 1 and 1A using Maxwell view, when the observer watches an image and a video, the convergence point of image light of the image and the video can be optimally located in the vicinity of the pupil of the observer. This can inhibit the occurrence of image loss and vignetting of an image at the time when the observer watches an image and a video. Moreover, in the retinal projection HMDs 1 and 1A, even when an image or a video having a wide angle of view of 30 degrees or more and approximately 60 degrees is displayed, the occurrence of vignetting in the display image can be inhibited, and the observer can always see the entire display image.

Note that the effects set forth in the present specification are merely examples and not limitations. Other effects may be exhibited.

Note that the present technology can also have the configurations as follows.
(1)

An image display device comprising:

a display unit, of transmissive type, that is allowed to converge light forming a display image in a pupil of an eyeball and project the light on a retina; and

a moving unit that is allowed to move the display unit in triaxial directions of an eye relief direction and two axial directions, the eye relief direction being a direction of a distance between the eyeball and the display unit, the two axial directions constituting a plane perpendicular to the eye relief direction.
(2)

The image display device according to (1),

wherein the moving unit includes a biaxial moving mechanism that is allowed to move the display unit in accordance with a position of the pupil of the eyeball in two axial directions, which are not parallel to each other, constituting a plane perpendicular to the eye relief direction.
(3)

The image display device according to (1) or (2),

wherein the biaxial moving mechanism includes an ultrasonic linear actuator.
(4)

The image display device according to any one of (1) to (3),

wherein the moving unit includes an eye relief direction moving mechanism that is allowed to move the display unit in the eye relief direction.
(5)

The image display device according to (4),

wherein the eye relief direction moving mechanism includes a hanging unit that hangs a holding unit, which holds the display unit, such that the holding unit is allowed to move in the eye relief direction.

(6)

The image display device according to (5),

wherein the hanging unit of the eve relief direction moving mechanism:

includes a screw feeding mechanism connected to the holding unit via a screw portion; and

is allowed to translate the display unit in the eye relief direction by rotating the screw portion of the screw feeding mechanism.
(7)

The image display device according to (5),

wherein the eye relief direction moving mechanism:

includes a lock mechanism that is allowed to mutually switch fixing and releasing between the hanging unit and the holding unit; and

is allowed to translate the display unit in the eye relief direction along a rail provided on the holding unit with the lock mechanism being released.
(8)

The image display device according to any one of (4) to (7),

wherein movement of the display unit caused by the eye relief direction moving mechanism is translation to a surface of the display unit.
(9)

The image display device according to any one of (4) to (8),

wherein the eye relief direction moving mechanism is allowed to manually move the display unit in the eye relief direction.
(10)

The image display device according to any one of (4) to (8),

wherein the eye relief direction moving mechanism is allowed to automatically move the display unit in the eye relief direction.
(11)

The image display device according to (10),

wherein the eye relief direction moving mechanism is allowed to move the display unit in accordance with a position of the pupil of the eyeball along the eye relief direction.
(12)

The image display device according to (10) or (11),

wherein the eye relief direction moving mechanism includes an ultrasonic linear actuator.
(13)

The image display device according to any one of (1) to (12),

wherein the display unit has a flat shape.
(14)

The image display device according to any one of (1) to (12),

wherein the display unit has a curved shape.
(15)

An adjustment method comprising:

a display step of displaying an adjustment image having a predetermined angle of view on a display;

a first following step of moving the display unit with the biaxial moving mechanism so that light forming the adjustment image is converged in a vicinity of a pupil of an eyeball with the pupil of the eyeball facing substantially a front;

a first eye relief adjustment step of moving the display unit in the eye relief direction with the eye relief direction moving mechanism so that an entire adjustment image is allowed to be visually recognized with the pupil of the eyeball facing substantially the front;

a second following step of moving the display unit in a perpendicular plane with the biaxial moving mechanism so that light forming the adjustment image is converged in a vicinity of the pupil of the eyeball with the pupil of the eyeball facing an end of the adjustment image; and

a second eye relief adjustment step of moving the display unit in the eye relief direction with the eye relief direction moving mechanism so that the entire adjustment image is allowed to be visually recognized with the pupil of the eyeball facing an end of the adjustment image,

wherein the first following step, the first eye relief adjustment step, the second following step, and the second eye relief adjustment step are repeatedly executed on an image display device until the entire adjustment image is made visible with the pupil of the eyeball facing substantially the front and facing the end of the adjustment image, the image display device including: a display unit that is allowed to converge light forming a display image in the pupil of the eyeball and project the light on a retina and that has translucency; and a moving unit including: an eye relief direction moving mechanism that is allowed to move the display unit in the eye relief direction, which is the direction of the distance between the eyeball and the display unit; and a biaxial moving mechanism that is allowed to move the display unit in two axial directions constituting a plane perpendicular to the eye relief direction.
(16)

The adjustment method according to (15),

in which an angle of view of the adjustment image is 30 degrees or more along an arrangement direction of the eyeball.

### REFERENCE SIGNS LIST

1, 1A RETINAL PROJECTION HEAD MOUNTED DISPLAY (RETINAL PROJECTION HMD)

2 WEARABLE BLOCK

2a TEMPLE

2b NOSE PAD

10 FRONT DISPLAY BLOCK

11 FRONT FRAME

12L LEFT OPTICAL BLOCK

12R RIGHT OPTICAL BLOCK

13L, 13R OPTICAL ENGINE UNIT

14L, 14R DISPLAY UNIT

15, 16, 17 EYE RELIEF ADJUSTMENT MECHANISM

15a, 17a WORN-SIDE MECHANISM

15b, 16b, 17b FRONT-SIDE MECHANISM

16a, 150, 173 WORN-SIDE MEMBER

20 ADJUSTMENT IMAGE

131 ENGINE BASE

132 X FRAME

132a, 133a, 174 MOVING OBJECT

133 Y FRAME

133b X-AXIS ULTRASONIC LINEAR ACTUATOR

134 Y-AXIS ULTRASONIC LINEAR ACTUATOR

151, 161 TAB PORTION

152 MALE SCREW PORTION

153 LINEAR MOTION GUIDE RAIL

154 FEMALE SCREW PORTION

162 TORSION COIL SPRING

163 GUIDE RAIL

164 STOPPER PORTION

165 TURNING SHAFT

171 PIEZOELECTRIC ELEMENT

172 DRIVE SHAFT

175 GUIDE RAIL

1. An image display device comprising:
a display unit, of transmissive type, that is allowed to converge light forming a display image in a pupil of an eyeball and project the light on a retina; and
a moving unit that is allowed to move the display unit in triaxial directions of an eye relief direction and two axial directions, the eye relief direction being a direction of a distance between the eyeball and the display unit, the two axial directions constituting a plane perpendicular to the eye relief direction.

2. The image display device according to claim 1,
wherein the moving unit includes a biaxial moving mechanism that is allowed to move the display unit in accordance with a position of the pupil of the eyeball in two axial directions, which are not parallel to each other, constituting a plane perpendicular to the eye relief direction.

3. The image display device according to claim 2,
wherein the biaxial moving mechanism includes an ultrasonic linear actuator.

4. The image display device according to claim 1,
wherein the moving unit includes an eye relief direction moving mechanism that is allowed to move the display unit in the eye relief direction.

5. The image display device according to claim 4,
wherein the eye relief direction moving mechanism includes a hanging unit that hangs a holding unit, which holds the display unit, such that the holding unit is allowed to move in the eye relief direction.

6. The image display device according to claim 5,
wherein the hanging unit of the eye relief direction moving mechanism:
includes a screw feeding mechanism connected to the holding unit via a screw portion; and
is allowed to translate the display unit in the eye relief direction by rotating the screw portion of the screw feeding mechanism.

7. The image display device according to claim 5,
wherein the eye relief direction moving mechanism:
includes a lock mechanism that is allowed to mutually switch fixing and releasing between the hanging unit and the holding unit; and
is allowed to translate the display unit in the eye relief direction along a rail provided on the holding unit with the lock mechanism being released.

8. The image display device according to claim 4,
wherein movement of the display unit caused by the eye relief direction moving mechanism is translation to a surface of the display unit.

9. The image display device according to claim 4,
wherein the eye relief direction moving mechanism is allowed to manually move the display unit in the eye relief direction.

10. The image display device according to claim 4,
wherein the eye relief direction moving mechanism is allowed to automatically move the display unit in the eye relief direction.

11. The image display device according to claim 10,
wherein the eye relief direction moving mechanism is allowed to move the display unit in accordance with a position of the pupil of the eyeball along the eye relief direction.

12. The image display device according to claim 10,
wherein the eye relief direction moving mechanism includes an ultrasonic linear actuator.

13. The image display device according to claim 1,
wherein the display unit has a flat shape.

14. The image display device according to claim 1,
wherein the display unit has a curved shape.

15. An adjustment method comprising:
a display step of displaying an adjustment image having a predetermined angle of view on a display;
a first following step of moving the display unit with the biaxial moving mechanism so that light forming the adjustment image is converged in a vicinity of a pupil of an eyeball with the pupil of the eyeball facing substantially a front;
a first eye relief adjustment step of moving the display unit in the eye relief direction with the eye relief direction moving mechanism so that an entire adjustment image is allowed to be visually recognized with the pupil of the eyeball facing substantially the front;
a second following step of moving the display unit in a perpendicular plane with the biaxial moving mechanism so that light forming the adjustment image is converged in a vicinity of the pupil of the eyeball with the pupil of the eyeball facing an end of the adjustment image; and
a second eye relief adjustment step of moving the display unit in the eye relief direction with the eye relief direction moving mechanism so that the entire adjustment image is allowed to be visually recognized with the pupil of the eyeball facing an end of the adjustment image,
wherein the first following step, the first eye relief adjustment step, the second following step, and the second eye relief adjustment step are repeatedly executed on an image display device until the entire adjustment image is made visible with the pupil of the eyeball facing substantially the front and facing the end of the adjustment image, the image display device including: a display unit that is allowed to converge light forming a display image in the pupil of the eyeball and project the light on a retina and that has translucency; and a moving unit including: an eye relief direct on moving mechanism that is allowed to move the display unit in the eye relief direction, which is the direction of the distance between the eyeball and the display unit; and a biaxial moving mechanism that is allowed to move the display unit in two axial directions constituting a plane perpendicular to the eye relief direction.
